(19) United States
(12) Patent Application Publication
(10) Pub. No.: US 2002/0191994 A1
(43) Pub. Date: Dec. 19, 2002

(54) Book scanning device

(76) Inventor: Yueh Shing Lee, Shin-Chu (TW)

Correspondence Address: Charles E. Baxley, Hart Baxley, Daniels & Holton, Fifth Floor, 59 John Street, New york, NY, 10038, US

(21) Appl. No.: 09/943,291

(22) Filed: Aug. 31, 2001

(30) Foreign Application Priority Data
Jun. 13, 2001 (TW) 090209875

(51) Int. Cl. G03G 15/00; G03B 27/32

(52) U.S. Cl. 399/362; 399/377; 355/25

(57) ABSTRACT

A scanner includes a body with an angled glass window and a movable optical module is connected in the body of the scanner. The optical module is moved in parallel with the gutter of the book to be scanned. The pages are matched on the angled glass window and the movable optical module moving in parallel with the gutter can scan images on the two consecutive pages of the book. The images at the gutter of the book can be clearly scanned.

### FIELD OF THE INVENTION

The present invention relates to a book scanner that is able to scan two consecutive pages at the same time.

### BACKGROUND OF THE INVENTION

As shown in FIG. 4, a conventional flatbed scanner 10 has a scanning window 12 in the body 11, and a movable optical module 13 is received in the body 11. When scanning a book 14, the book 14 is opened and put on the scanning window 12.

The size of the scanning window 12 of the conventional flatbed scanner 10 is made to accept a size less than an A4 sheet so that only one page can be scanned on the conventional flatbed scanner 10.

Besides, when putting the opened book 14 on the scanning window 12, the gutter 15 between two consecutive pages is located above the scanning window 12 so that the images at the gutter 15 will be deformed and shaded, which are known as bad scanning quality.

Referring to FIG. 5 showing another book scanning device 16, an angled scanning window 18 is installed on the body 17 and a movable optical module 19 is movably received in the body 17 (the transferring mechanism for moving the movable optical module is not shown in the drawing). When scanning the book 14, the gutter 15 of the book 14 is put on the ridge 21 of the scanning window 18 so that the pages are matched on the scanning window 18. The scanning device 16 obviously uses the angled ridge to eliminate the conventional scanning problem for the gutter 15 of the book 14.

Due to the gutter 15 of the book 14 is located on a side of the scanning device 16, the optical module 19 has to located close to the edge of the scanning device 16 to obtain the images on the gutter 15 to completely scan the book 14. Furthermore, the optical module 19 is checked by processes of adjusting color and brightness and checking the leading edge before it is operated so as to obtain precise scanning and movement. Therefore, the optical module 19 has to start from the right side of the figure to check and find the edge, and then moved to the left side to scan the book 14. There is an empty section for the optical module 19 during moving through the scanning window 18. This elongates the time of scanning and which does not meet the requirements of high speed and quality for book scanning device.

In addition, since the optical module 19 of the scanning device 16 only moves along the horizontal portion 22 of the scanning window 18, there is no corresponding optical module 19 for scanning the book 14 at the inclined portion 23 of the scanning window 18. Only one page can be canned each time of the scanning device 16. Besides, the starting position of the optical module 19 cannot be located close to the side of the inclined portion 23 because the limitation of the structure, otherwise, the optical module 19 cannot proceed the processes of checking and finding starting point.

As shown in FIG. 6, the scanning device 24 is able to scan two pages and has an angled scanning window 26 installed in the body 25. An angled guiding rod 27 is mounted in the body 25. Two optical modules 28 and 29 are connected to the angled guiding rod 27 and located corresponding to the scanning window 26.

When scanning the book 14, the gutter 15 of the book 14 is put on the ridge 31 of the scanning window 26 so that the two consecutive pages are matched on the horizontal portion 32 and the inclined portion 33 of the scanning window 26. The two pages are scanned when the two optical modules 28 and 29 are moved.

The scanning device 24 needs two optical modules 28 and 29 which are moved along two different directions. Therefore, two different transferring mechanisms (not shown) are required to drive the two optical modules 28 and 29. The two transferring mechanisms are complicated so that it involves a complicate structure and higher cost.

### SUMMARY OF THE INVENTION

The present invention relates to a book scanner which scans the book along the direction of the gutter so as to scan two consecutive pages at one time and clearly scan the images on both sides of the gutter. The mechanism of the scanner is simple and the manufacturing cost is reduced.

In order to achieve the purpose above, an angled scanning window is connected to a top of the body so that the book is put on the scanning window. An optical module is received in the body and movable in parallel with the gutter of the book. The optical module comprises two reflection mirrors, two lenses and two images sensing elements. The optical module simply moves along the gutter to scan the images on the two pages of the book.

### BRIEF DESCRIPTION OF THE DRAWINGS

FIG. 1 is a perspective view to show the scanner of the present invention;

FIG. 2 is a top plan view of the scanner of the present invention;

FIG. 3 is an illustrative view of the scanner of the present invention;

FIG. 4 is an illustrative view of a conventional flatbed scanner;

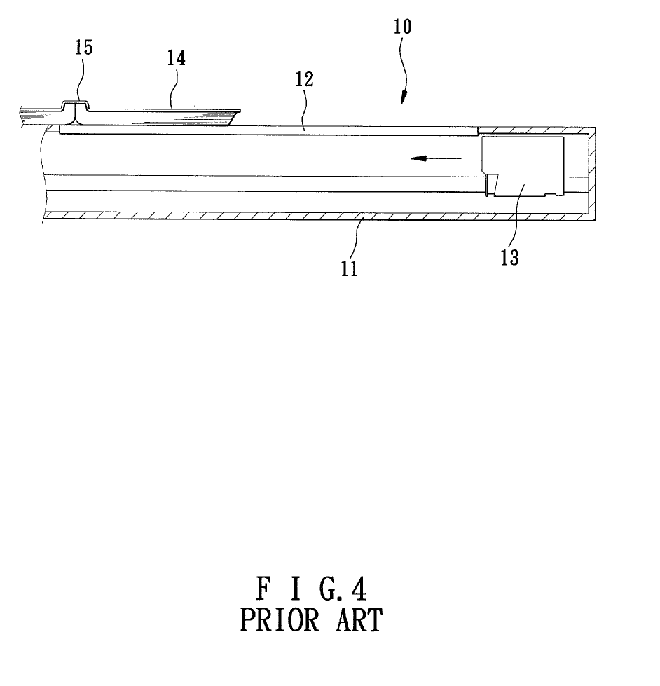

FIG. 5 is an illustrative view of the conventional flatbed scanner; and

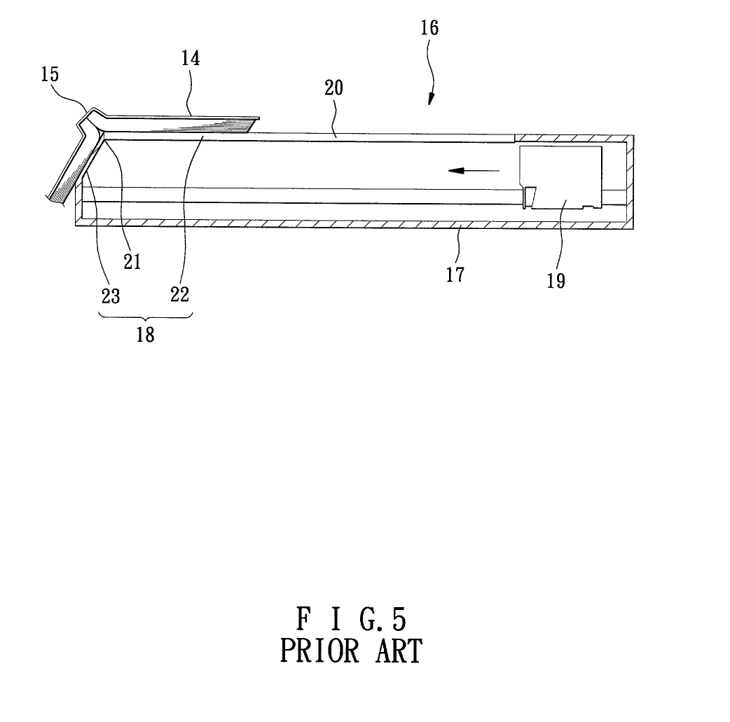

FIG. 6 is an illustrative view of another conventional flatbed scanner;

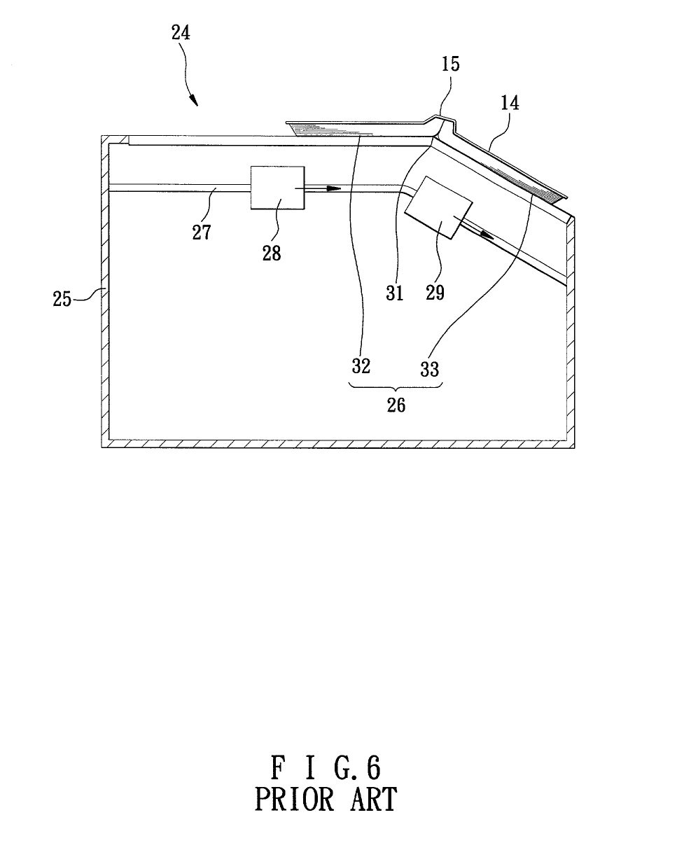

### DETAILED DESCRIPTION OF THE PREFERRED EMBODIMENT

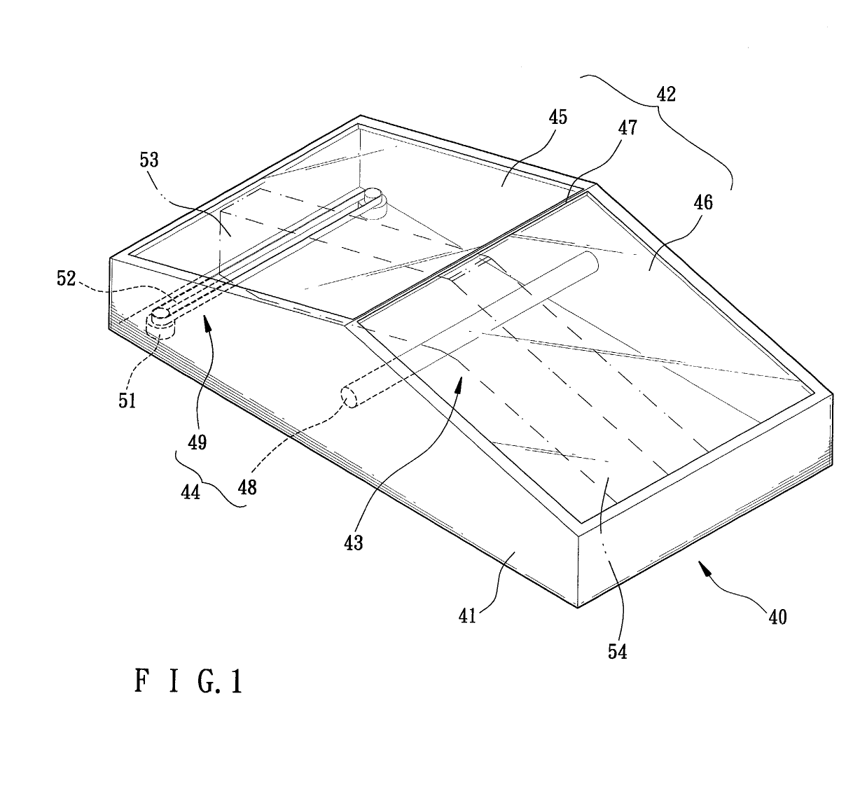

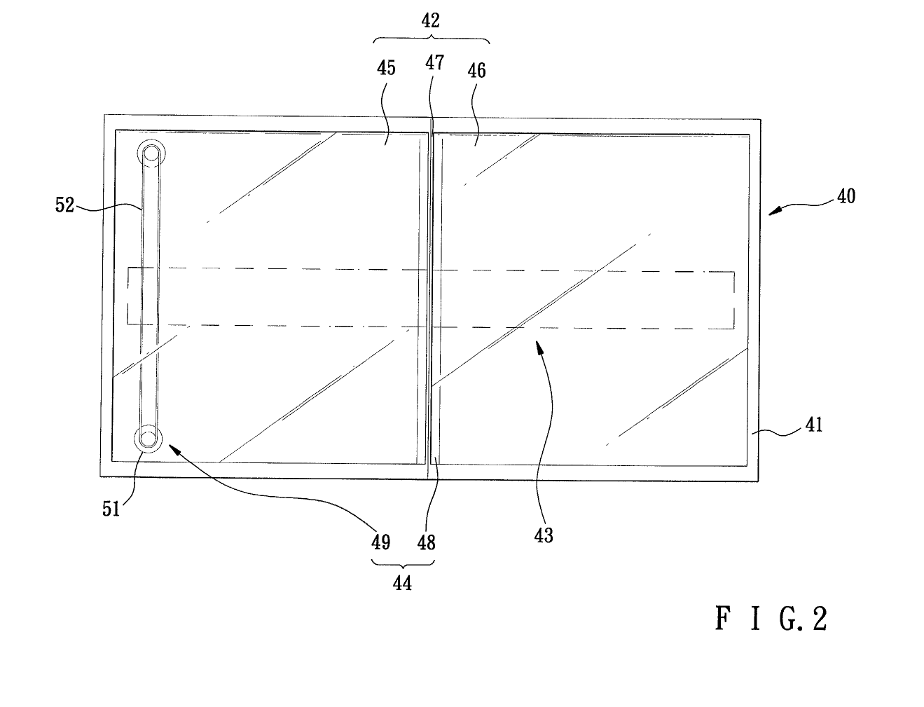

Referring to FIGS. 1 and 2, the book scanner 40 of the present invention comprises a body 41 having a glass window 42 connected on the top thereof, an optical module 43, and a transmission mechanism 44 for driving the optical module 43.

The glass window 42 has a first portion 45 and a second portion 46 adjacent to the first portion 45. An angle is defined between the first portion 45 and the second portion 46.

The angled glass window 42 can be made by bending a piece of transparent glass, or connecting two pieces of transparent glasses. The conjunction of the first portion 45 and the second portion 46 of the glass window 42 becomes a ridge 47. It is to be noted that the ridge 47 formed by bending a piece of transparent glass could not be obvious, however, it exists.

The transmission mechanism 44 at least comprises a guiding rod 48 and a transmission unit 49. The guiding rod 48 is located in parallel with the ridge 47. The transmission unit 49 may include a motor 51 and a belt 52 for moving the optical module 43. The motor 51 of the transmission unit 49 may be connected to the body 41, or connected to the bottom of the optical module 43.

Regarding to the arrangement of the guiding rod 48, two arrangements are provided in this embodiment, the first one is that only one guiding rod 48 is provided under the ridge 47, as shown in FIG. 1. An alternative way is that two guiding rods 48 are provided in the body 41 at the opposite sides away from the ridge 47. The guiding rod 48 has to be in parallel with the ridge 47 regardless of the number of the guiding rod(s) 48.

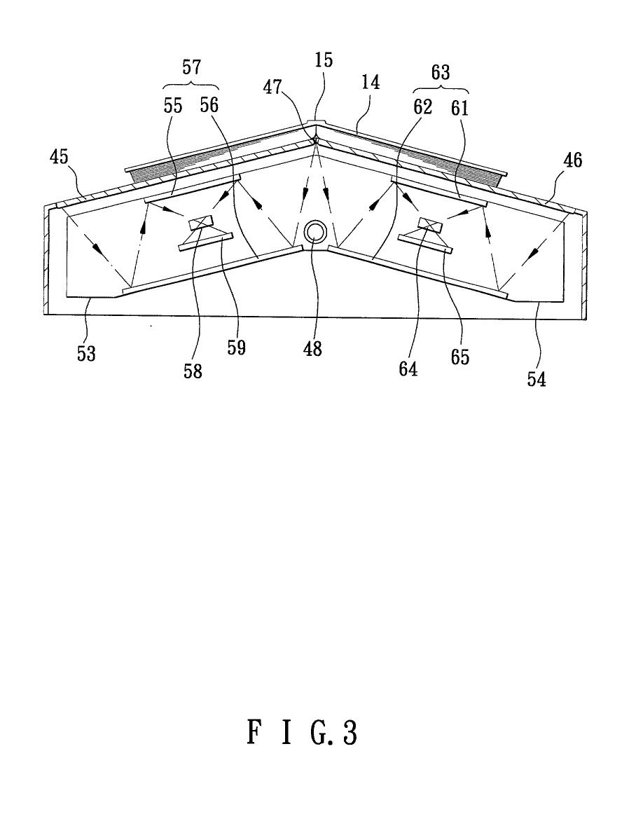

Referring to FIGS. 1 and 3, the optical module 43 is connected to the guiding rod 48 and driven by the transmission unit 49 so as to be moved along the guiding rod 48.

The optical module 43 has a first portion 53 and a second portion 54 adjacent to the first portion 53. An angle is defined between the first portion 53 and the second portion 54. The first portion 53 and the second portion 54 are located in corresponding to the first portion 45 and the second portion 46 of the glass window 42.

A reflection mirror set 57 composed of a first reflection mirror 55 and a second reflection mirror 56 is received in the first portion 53 of the optical module 43. A lens 58 and an image sensor 59 such as a CCD, are received in the reflection mirror set 57.

The second portion 54 of the optical module 43 has a reflection mirror set 63 composed of a first reflection mirror 61 and a second reflection mirror 62. A lens 64 and an image sensor 65 are received in the reflection mirror set 63. The lens 64 is located between the image sensor 65 and the first reflection mirror 61.

Before using the scanner, the book 14 is opened and ridge 47 is engaged with the gutter 15 of the book 14, the consecutive pages of the book 14 are put on the surfaces of the first portion 45 and the second portion 46 of the glass window 42. By this way, the book 14 can be conveniently placed on the glass window 42. During scanning, the optical module 43 is moved along the guiding rod 48. In other words, the optical module 43 is moved in parallel with the gutter 15 of the book 14. The first portion 53 and the second portion 54 of the optical module 43 are located in parallel with the first portion 45 and the second portion 46 of the glass window 42, respectively. The first portion 53 and the second portion 54 of the optical module 43 have lenses 58 and 64 and image sensors 59 and 65 for receiving images, so that the images on the two pages can be simultaneously clearly scanned.

Because of the parallel movement of the optical module 43 along the gutter 15 of the book 14, the scanning lines (not shown) for scanning images provided by the optical module 43 can precisely be projected on the position of the gutter 15 of the book 14. Therefore, a better quality of scanning for the image at the gutter 15 can be obtained.

The invention uses only one optical module 43 and the optical module 43 is simply controlled to move along one direction. The structure and the stroke control are simplified so as to not only reduce the manufacturing cost but also meet the rapid and precise requirement of the scanner.

The scanner of the present invention not only can scan books, but also can scan general documents. The document can be scanned by putting the document on the first portion 45 and/or the second portion 46.

While we have shown and described the embodiment in accordance with the present invention, it should be clear to those skilled in the art that further embodiments may be made without departing from the scope of the present invention.

What is claimed as:

1. A scanner comprising:
a body;
a glass window connected to said body and having a first portion and a second portion, an angle defined between said first portion and said second portion, a ridge being formed at a conjunction between said first portion and said second portion;
an optical module installed in said body and located in corresponding to said glass window so as to provide a function of scanning images; and
a transmission mechanism connected to said optical module and driving said optical module in a direction parallel with said ridge.

2. The scanner as claimed in claim 1, wherein said transmission mechanism comprises a guiding rod whose axis is parallel with said ridge of said glass window, and said optical module is connected to said guiding rod.

3. The scanner as claimed in claim 1, wherein said transmission mechanism comprises a transmission unit which is connected between said body and said optical module so as to drive said optical module in parallel with said ridge of said glass window.

4. The scanner as claimed in claim 1, wherein said optical module has a first portion and a second portion which is located adjacent to said first portion, an angle defined between said first portion and said second portion, each of said first portion and said second portion having a reflection mirror set to reflect scanned images, lenses and image sensors located in a path of scanning.

5. The scanner as claimed in claim 1, wherein said optical module has a first portion and a second portion which is located adjacent to said first portion, an angle defined between said first portion and said second portion, said first portion and said second portion of said optical module located in parallel with said first portion and said second portion of said glass window.

6. The scanner as claimed in claim 1, wherein said glass window is made by bending a piece of transparent glass to form said first portion and said second portion.

7. The scanner as claimed in claim 1, wherein said glass window is made by connecting two pieces of transparent glass to form said first portion and said second portion.

8. The scanner as claimed in claim 1, wherein said guiding rod of said transmission mechanism is located below said ridge of said glass window.

9. The scanner as claimed in claim 1, wherein said transmission mechanism is connected to said body.

10. The scanner as claimed in claim 1, wherein said transmission mechanism is connected to said optical module.
